(19) United States
(12) Patent Application Publication
(10) Pub. No.: US 2016/0267461 A1
(43) Pub. Date: Sep. 15, 2016

(54) APPARATUS AND METHOD FOR PROCESSING A TRANSACTION FOR RECEIVING AND PAYING CASH

(71) Applicant: Nautilus Hyosung Inc., Seoul (KR)

(72) Inventor: Bo Ick CHANG, Seongnam-si (KR)

(21) Appl. No.: 14/716,751

(22) Filed: May 19, 2015

(30) Foreign Application Priority Data
Mar. 10, 2015 (KR) 10-2015-0033073

(51) Int. Cl. G06Q 20/32; G06Q 20/38; G06Q 20/10

(52) U.S. Cl. CPC G06Q 20/3223; G06Q 20/1085; G06Q 20/3829; G06Q 20/327; G06Q 2220/00

(57) ABSTRACT

The present invention provides a method for processing, in an automated teller machine, a transaction of a cash deposit or withdrawal requested by a mobile terminal, including receiving card information and second security information stored in the mobile terminal, transmitting an alarm message, which is indicative of an approach of the mobile terminal to the automated teller machine, to the mobile server, receiving transaction information, which has been written by the mobile terminal and then provided to the mobile server, and first security information, which is stored in the mobile server, from the mobile server and requesting a financial computer network associated with the automated teller machine (ATM) to process the transaction, based on the card information, the first security information, the second security information, and the transaction information.

### CROSS-REFERENCE TO RELATED APPLICATIONS

This application is based on and claims priority to Korean Patent Application No. 10-2015-0033073, filed on Mar. 10, 2015, the disclosures of which is incorporated herein in its entirety by reference.

### FIELD OF THE INVENTION

The present invention relates to apparatus and method for processing a transaction for receiving and paying cash, and in particular, relates to apparatus and method for processing a transaction for receiving and paying cash requested by the mobile terminal.

### BACKGROUND OF THE INVENTION

Rapid growth of mobile transactions and the advent of mobile payment systems have an effect on even Automated Teller Machines (ATMs). For example, there is a need for a mobile-linked ATM in which a user can withdraw cash from an ATM using his/her mobile terminal after the user has received a pre-approval for a transaction of cash deposit or withdrawal.

In order to meet the aforementioned need, as illustrated in FIG. 1, it is required to interlink actual data between a mobile transaction server 22 and an ATM switch server 23, which have separate server environments, respectively, within a financial computer network 20. That is, a request for a cash deposit or withdrawal transaction from the mobile terminal should be forwarded to the ATM switch server 23 that process transactions for an ATM 25 through the mobile transaction server 22 that processes transactions for the mobile terminal 24.

However, since the traditional financial computer network 20 does not have a configuration to interlink data between the mobile transaction server 22 and the ATM switch server 23, the traditional financial computer network is needed to be restructured in order to interlink data between the mobile transaction server 22 and the ATM switch server 23.

However, most of financial institutions may not want to restructure their traditional financial computer networks 20 because they are concerned about the risk of the change and the possibility of an increase in investment.

Consequently, while there is a need for a mobile-linked ATM, it is not yet active.

In addition, conventional security solutions merely provide security for mobile banking services using mobile terminals and do not provide security for transactions of cash deposits or withdrawals through the mobile-linked ATM using the mobile terminals.

### SUMMARY OF THE INVENTION

In view of the above, an embodiment of the present invention provides a mobile-linked apparatus and method for processing a transaction for receiving and paying cash.

In accordance with an embodiment of the present invention, there is provided a method for processing, in an automated teller machine, a transaction of a cash deposit or withdrawal requested by a mobile terminal, the method includes receiving card information and second security information stored in the mobile terminal, transmitting an alarm message, which is indicative of an approach of the mobile terminal to the automated teller machine, to a mobile server, receiving transaction information, which has been written by the mobile terminal and then provided to the mobile server, and first security information, which is stored in the mobile server, from the mobile server and requesting a financial computer network associated with the automated teller machine (ATM) to process the transaction, based on the card information, the first security information, the second security information, and the transaction information, and the first security information and the second security information are combined each other to form a password of a card of a user who owns the mobile terminal.

In the embodiment, card information stored in the mobile terminal is the second security information that is a part of the card information on the card; the mobile server is configured to store in advance first card information that is a remainder of the card information on the card except for the second card information; said receiving transaction information and first security information includes additionally receiving the first card information; and said requesting a financial computer network to process the transaction comprises requesting the financial computer network associated with the automated teller machine (ATM) to process the transaction, based on the first card information, the second card information, the first security information, the second security information, and the transaction information.

In the embodiment, the method further includes recognizing the mobile terminal's approach.

In the embodiment, the first security information and the second security information are combined to form a set of a key to encrypt a password of the card and the password to be encrypted by the key.

In the embodiment, wherein said requesting a financial computer network to process the transaction includes combining the first security information and the second security information to derive the key to encrypt a password of the card and the password to be encrypted by the key; decrypting the encrypted password using the key; re-encrypting the password, which has been decrypted, using an encryption unit included in the automated teller machine; and requesting the financial computer network associated with the automated teller machine (ATM) to process the transaction, based on the re-encrypted password, the card information and the transaction information.

In the embodiment, said encryption unit is EPP (Encrypting Pin Pad) module.

In the embodiment, said receiving transaction information and first security information includes additionally receiving the reservation information; the alarm message includes the reservation information; the mobile server is configured to include the transaction information that is identified by the reservation information; the transaction information, which is received at said receiving transaction information and first security information, is identified by the reservation information; and the reservation information is generated by the mobile terminal.

In the embodiment, at least one of the transaction information and the first security information stored in the mobile server is deleted when a predetermined time has been elapsed.

In accordance with an embodiment of the present invention, there is provided an automated teller machine (ATM) for processing a transaction of cash deposit or withdrawal requested by a mobile terminal, the automated teller machine includes a communication unit; and a control unit configured to: upon receiving card information and second security information stored in the mobile terminal, allow the mobile terminal to transmit an alarm message, which is indicative of an approach of the mobile terminal to the automated teller machine, to a mobile server via the communication unit; and upon receiving transaction information, which has been written by the mobile terminal and then provided to the mobile server, and first security information, which is stored in the mobile server, via the communication unit, request a financial computer network associated with the automated teller machine (ATM) to process the transaction, based on the card information, the first security information, the second security information, and the transaction information; wherein the first security information and the second security information are combined with each other to form a password of a card of a user who owns the mobile terminal.

In the embodiment, the card information stored in the mobile terminal is the second security information that is a part of the card information on the card; the mobile server is configured to store in advance first card information that is a remainder of the card information on the card except for the second card information; and if the control unit receives the first card information through the communication unit in addition to the second card information, the first security information, the second security information, and the transaction information, the control unit is configured to request a financial computer network to process the transaction comprises requesting the financial computer network associated with the automated teller machine (ATM) to process the transaction, based on the first card information, the second card information, the first security information, the second security information, and the transaction information.

In the embodiment, the first security information and the second security information are combined to form a set of a key to encrypt a password of the card and the password to be encrypted by the key.

In the embodiment, the control unit is configured to combine the first security information and the second security information to derive the key to encrypt a password of the card and the password to be encrypted by the key and the automated teller machine further comprises a decryption unit, the decryption unit decrypting the encrypted password using the key.

In the embodiment, the automated teller machine further includes an encryption unit configured to re-encrypt the password, which has been decrypted, and the control unit requests the financial computer network associated with the automated teller machine (ATM) to process the transaction, based on the re-encrypted password, the card information and the transaction information.

In the embodiment, wherein said encryption unit is EPP (Encrypting Pin Pad) module.

In the embodiment, the control unit receives transaction information and second security information and additionally receives the reservation information via the communication unit; the alarm message includes the reservation information; the mobile server is configured to include the transaction information that is identified by the reservation information; the transaction information which is received from said mobile server is identified by the reservation information; and the reservation information is generated by the mobile terminal.

In the embodiment, at least one of the transaction information and the first security information stored in the mobile server is deleted when a predetermined time has been elapsed.

According to an embodiment of the present invention, a request for a transaction of cash deposit or withdrawal from the mobile terminal can be forwarded to the automated teller machine (ATM) via the mobile terminal, rather than the traditional financial network. Accordingly, it is possible for the automated teller machine (ATM) to perform the transaction of a cash deposit or withdrawal without forging the traditional financial network. Further, the security information and card information necessary for the transaction of a cash deposit or withdrawal are divided into segments and distributed between the mobile terminal and the mobile server before being transferred and combined by the automated teller machine (ATM) in accordance with an embodiment of the present disclosure, thereby avoiding the leakage of the information by a third party and preventing cash from being stolen due to the leaked information.

### BRIEF DESCRIPTION OF THE DRAWINGS

The above and other objects and features of the present invention will become apparent from the following description of the embodiments given in conjunction with the accompanying drawings, in which:

FIG. 1 shows an exemplary configuration where a conventional mobile-linked ATM is interlinked with a financial computer network;

FIG. 2 shows an exemplary configuration where an automated teller machine (ATM) is interlinked with a financial computer network in accordance with an embodiment of the present disclosure;

FIG. 3 depicts an exemplary diagram illustrating a scenario that information on a card is divided into for the mobile terminal and the mobile server and then transferred to and combined in the automated teller machine;

FIG. 4 depicts an exemplary diagram illustrating a scenario that security information is divided into for the mobile terminal and the mobile server and then transferred to and combined in the automated teller machine;

FIG. 5 shows an exemplary diagram of a configuration of the automated teller machine (ATM) 100 in accordance with an embodiment of the present disclosure;

FIG. 6 is an exemplary sequential diagram illustrating a process of performing a transaction of cash deposit or withdrawal in a system including the automated teller machine (ATM) 100, the mobile terminal 300, the mobile server 200, and the financial computer network 20 in accordance with an embodiment of the present disclosure;

FIG. 7 is an exemplary flow diagram illustrating a sequence in which a transaction of cash deposit or withdrawal is processed in the automated teller machine (ATM) in accordance with an embodiment of the present disclosure.

### DETAILED DESCRIPTION OF THE EMBODIMENTS

Hereinafter, exemplary embodiments of the present invention will be described in detail with reference to the accompanying drawings. It should be understood that the present invention is not intended to be limited to those embodiments, but intended to to describe the embodiments in detail so as for a person having an ordinary skill in the art to easily carry out them.

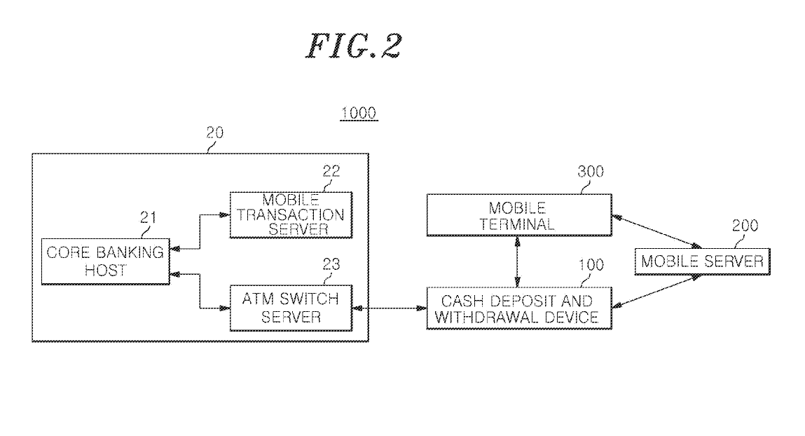

FIG. 2 shows an exemplary configuration where an automated teller machine (ATM) is interlinked with a financial computer network in accordance with an embodiment of the present disclosure.

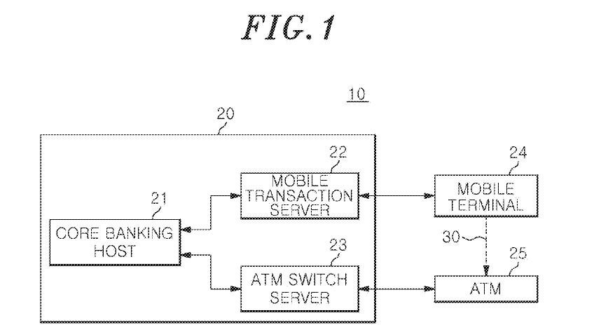

Referring to FIG. 2 along with FIG. 1, as compared to FIG. 1, an automated teller machine (ATM) 100 is mutually connected to a mobile server 200 to constitute a network along with a mobile terminal 300 and a financial computer network 20 in accordance with an embodiment of the present disclosure.

The financial computer network 20 includes a core banking host 21, a mobile transaction server 22 that processes transactions for the mobile terminal 300, and an ATM switch server 23 that processes transactions for the automated teller machine (ATM) 100.

In this embodiment, the financial computer network 20 as illustrated in FIG. 2 is substantially identical to the traditional financial computer network 20 as illustrated in FIG. 2. That is, in case where the automated teller machine (ATM) 100 in accordance with an embodiment of the present disclosure is capable of processing a transaction of cash deposit or withdrawal requested by the mobile terminal 300, it is not required to restructure the traditional financial computer network 20 so as to allow data to be interlinked between the mobile transaction server 22 and the ATM switch server 23. Accordingly, the traditional financial computer network 20 may be employed in this embodiment without being restructured.

The mobile terminal 300 is a portable device carried by a user, which that is capable of performing such functions as transactions of cash deposit or withdrawal, account inquiries, and the like in a mobile environment. Such a mobile terminal may include, for example, smart phones, smart pads, etc., but is not limited thereto.

The mobile server 200 is a device capable of storing data, for example, such as security information including passwords required for transactions of cash deposit or withdrawal, card information, transaction information on the transactions of cash deposit or withdrawal, reservation information identifying the relevant transaction information, and others, and sending and receiving the aforementioned data in a wired or wireless communication. The mobile server 200 may include, but is not limited to, for example, personal computers, note-book computers, laptop computers, serves, and others. To do it, although not shown in the drawing, the mobile server 200 may include a storage unit to store data, a communication unit to send and receive the relevant data in a wired or wireless communication, and the like. At least any one of the security information, the card information, the transaction information, and the reservation information may be automatically deleted when a predetermined time has elapsed. Therefore, it is possible to fundamentally prevent the relevant information from being stolen by a third party in the future.

Herein, the mobile server 200 may be an independent device separated from the financial computer network 20 or the automated teller machine (ATM) 100, as illustrated in FIG. 2. In other words, a transaction of cash deposit or withdrawal requested by the mobile terminal 300 may be accomplished by separately configuring the mobile server 200 without modification or addition of any functions to the traditional financial computer network 20 or the automated teller machine (ATM) 100.

It is, however, noted that the embodiment of the present disclosure is not intended to confine that the mobile server 200 is configured as the independent device separated from the financial computer network 20 or the automated teller machine (ATM) 100. For example, the mobile server 200 may be embodied to be included in the ATM switch server 23 or the automated teller machine (ATM) 100 within the financial computer network 20 depending on embodiments. Hereinafter, however, a description will be made on the assumption that the mobile server 200 is configured as the independent device separated from the financial computer network 20 or the automated teller machine (ATM) 100.

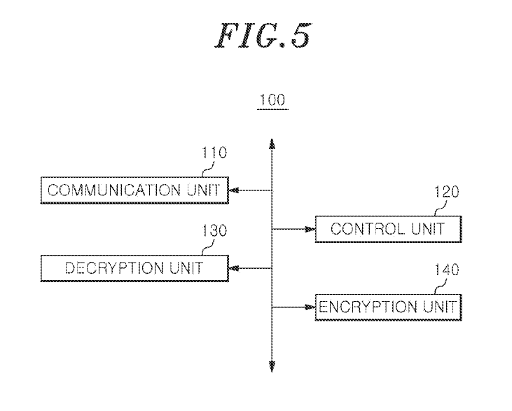

The automated teller machine (ATM) 100 in accordance with an embodiment of the present disclosure is a device that process a transaction of cash deposit or withdrawal in cooperation with the financial computer network 20 when the transaction is requested by the mobile terminal 300 and may perform a function of Automated Teller Machine (cash deposit or withdrawal device), of which description will be made in detail with reference to FIG. 5.

In the embodiment, the mobile terminal 300 may be connected to the automated teller machine (ATM) 100 using a wireless communication technique, for example, such as NFC (Near Field Communication), RF (Radio Frequency), Wi-Fi (Wireless-Fidelity), QR (Quick Response) code, 3G, 4G, LTE (Long Term Evolution), LTE-A (Long Term Evolution-Advanced), etc., but is not limited thereto. Further, the mobile terminal 300 may be connected to the mobile server 200 using a wireless communication technique, for example, such as 3G, 4G, LTE (Long Term Evolution), LTE-A (Long Term Evolution-Advanced), etc., but is not limited thereto. Meanwhile, the automated teller machine (ATM) 100 may be connected with the automated teller machine (ATM) 100 using a wired or wireless communication technique, for example, such as RS-232, RS-422, RS-485, wired-line Internet communication, NFC, RF, Wi-Fi, QR code, 3G, 4G, LTE (Long Term Evolution), LTE-A (Long Term Evolution-Advanced), etc., but is not limited thereto.

Referring back to FIG. 2, there is illustrated in FIG. 2 that the mobile terminal 300 and the mobile transaction server 22 are not connected with each other in consideration of a case where data, which is required for a transaction of cash deposit or withdrawal when the mobile terminal 300 requests the transaction, is directly forwarded to the automated teller machine (ATM) 100 without passing through the mobile transaction server 22 (or the financial computer network 20) and the transaction is then ultimately carried out at the automated teller machine (ATM) 100 based on the relevant data. However, the mobile terminal 300 may be connected to the mobile transaction server 22 when it needs to receive a mobile banking service in addition to the transaction of cash deposit or withdrawal or even a transaction of cash deposit or withdrawal so that the mobile terminal can receive the service.

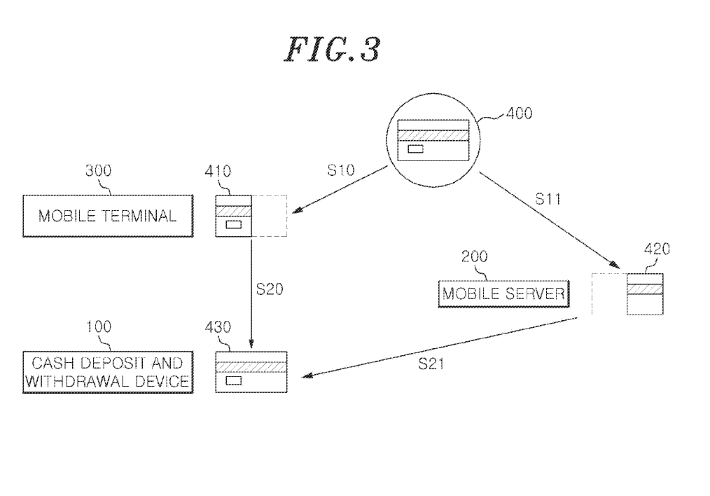

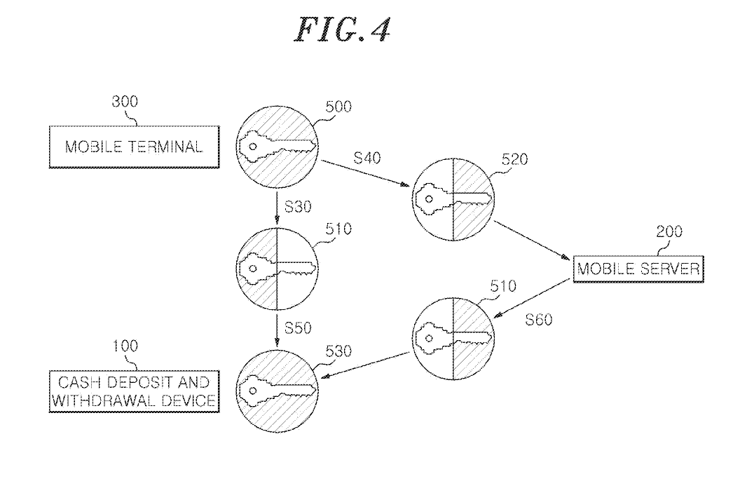

Meanwhile, when the mobile terminal 300 requests a transaction of cash deposit or withdrawal, it is required to secure data used in the transaction. More specifically, the transaction of cash deposit or withdrawal requested by the mobile terminal 300 does not pass through the mobile transaction server 22 provided with a security function. Accordingly, a financial accident may occur when data exchanged between the mobile terminal 300 and the mobile server 200 and the automated teller machine (ATM) 100 is stolen (or hooked) or forged by a third party. In order to avoid the accident, the embodiment of the present disclosure provides a method to reinforce the security of information on cards and passwords of the relevant cards among data necessary for a transaction of cash deposit or withdrawal, which will be described with reference to FIGS. 3 and 4 hereinbelow.

FIG. 3 depicts an exemplary diagram illustrating a scenario that information on a card is divided into for the mobile terminal and the mobile server and then transferred to and combined in the automated teller machine.

Referring to FIG. 3, card information 400 is divided into two parts, which are in turn stored in the mobile terminal 300 and the mobile server 200 in advance, as in operations S10 and S11. For example, the mobile terminal 300 may store second card information 410 that is a part of the card information 400 and the mobile server 200 may store first card information 420 that is a remainder of the card information except for the second card information 410. In this case, dividing the card information into the second card information 410 and the first card information 420 may be done, for example, by physically assigning a part of a card number to the second card information 410 and a remainder of the card number to the first card information 420 or by dividing the card information using XOR operation, but is not limited thereto.

The second card information 410 and the first card information 420 are then transferred and combined in the automated teller machine (ATM) 100 when a transaction of cash deposit or withdrawal is requested by the automated teller machine (ATM) 100. As illustrated in FIG. 3, when the transaction of cash deposit or withdrawal is requested, the second card information 410 is transferred to the automated teller machine (ATM) 100 from the mobile terminal 300, as in an operation S20, and the first card information 420 is transferred to the automated teller machine (ATM) 100 from the mobile server 200, as in an operation S21. The automated teller machine (ATM) 100 may then combine the second card information 410 and the first card information 420 to obtain whole card information 430 and request the financial computer network 20 to process the transaction of cash deposit or withdrawal based on the whole card information.

Accordingly, even if a third party steals or forges the card information during transferring the card information in operations S20 and S21, it is not possible for the third party to fake the transaction of cash deposit or withdrawal using the card information, thereby reinforcing the security. This is because that the card information transferred between the mobile terminal 300 and the automated teller machine (ATM) 100 and the mobile server 200 (e.g., in operations S20 and S21) are merely parts of the whole card information. Meanwhile, as stated above, it is noted that the first card information 420 stored in the mobile server 200 may be automatically deleted when a predetermined time has elapsed.

Herein, in case where a customer who possess a traditional card for cash deposit or withdrawal wants to perform a transaction of cash deposit or withdrawal using a his/her mobile terminal 300 in the automated teller machine, the automated teller machine (ATM) may read the card to identify card information on the card and allow the card information to be divided and stored in the mobile terminal 300 and the mobile server 200. To do it, although not shown in the drawing, the automated teller machine (ATM) 100 may be configured to include additional components for scanning a card for cash deposit or withdrawal, reading card information on the card, dividing the card information to store the divided card information in the mobile terminal 300 and the mobile server the mobile server 200.

In contrast, in case where a new customer wants a transaction of cash deposit or withdrawal using a his/her mobile terminal 300 in the automated teller machine, card information, which has been produced at the time of new registration of the card, may be allowed to be divided and stored in the mobile terminal 300 and the mobile server 200.

FIG. 4 depicts an exemplary diagram illustrating a scenario that security information is divided into for the mobile terminal and the mobile server and then transferred to and combined in the automated teller machine.

Referring to FIG. 4, security information 500 is divided into two parts, which are in turn stored in the mobile terminal 300 and the mobile server 200, as in operations S30 and S40. For example, the mobile terminal 300 may store second security information 510 that is a part of the security information 500 and the mobile server 420 may store first security information 520 that is a remainder of the security information 500 except for the second security information 510. In this case, dividing the security information into the second security information 510 and the first security information 520 may be done, for example, by physically assigning a part of the security information to the second security information 510 and a remainder of the security information to the first security information 520 or by dividing the security information using XOR operation, but is not limited thereto.

The second security information 510 and the first security information 520 may be combined to form a PIN (a Personal Identification Number) of a card necessary for a transaction of cash deposit or withdrawal.

Additionally or alternatively, the second security information 510 and the first security information 520 may be combined to form a key that will be used to encrypt a password of a card and the password to be encrypted by the key. In this example, the second security information 510 may contain, for example, a part of the key and encrypted password, and the first security information 520 may contain a remainder of the key and encrypted password. The key may include a one-time random number generated randomly. Encrypting a password using a key is one of encryption methods using a random number and is a well-known technology in the art, and therefore, a description thereof will be omitted.

The second security information 510 and the first security information 420 are then transferred to and combined in the automated teller machine (ATM) 100. For example, as illustrated in FIG. 4, the second security information 510 is transferred to the automated teller machine (ATM) 100 from the mobile terminal 300, as in an operation S50, and the first security information 520 is transferred to the automated teller machine (ATM) 100 from the mobile server 200, as in an operation S60. The automated teller machine (ATM) 100 may then combine the second security information 510 and the first security information 520 to obtain whole security information 530 and request the financial computer network 20 to process the transaction of cash deposit or withdrawal based on the relevant whole security information. Meanwhile, as stated above, it is noted that the first security information 520 stored in the mobile server 200 may be automatically deleted when a predetermined time has elapsed.

Therefore, even if a third party steals or forges the security information during transferring the security information in operations S30, S40, S50, and S60, the third party cannot fake the transaction of cash deposit or withdrawal using the stolen or forged security information, which lead to reinforcing the security. This is because that the security information transferred between the mobile terminal 300 and the automated teller machine (ATM) 100 and the mobile server 200 (e.g., in operations S30, S40, S50, and S60) are merely parts of the whole security information.

Meanwhile, in accordance with an embodiment of the present disclosure, the card information in FIG. 3 may be divided into two parts, which are in turn pre-stored in the mobile terminal 300 and the mobile server 200 before the transaction of cash deposit or withdrawal.

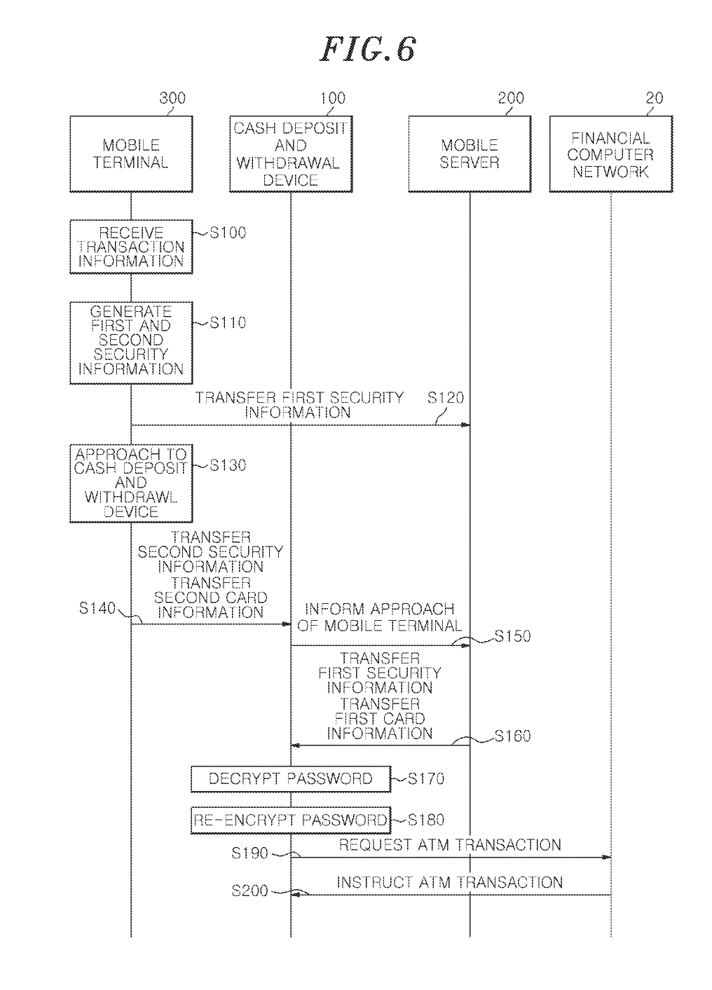

Further, in accordance with an embodiment of the present disclosure, the security information in FIG. 4 may be generated only after there is a request for a transaction of cash deposit or withdrawal, divided into two parts, and then stored in the mobile server 200 and the mobile terminal 300, of which description will be made in detail with reference to FIG. 6.

FIG. 5 shows an exemplary diagram of a configuration of the automated teller machine (ATM) 100 in accordance with an embodiment of the present disclosure.

Referring to FIG. 5, the automated teller machine (ATM) 100 may include a communication unit 110, a control unit 120, a decryption unit 130, and an encryption unit 140. It is, however, understood that the embodiment is merely an example of the present disclosure, and the present disclosure may include any component(s) that is not shown herein or may not include any one of components that are shown herein depending on embodiments.

The communication unit 110 exchanges data by the use of wired or wireless communication technique, for example, such as LAN, Wi-Fi, NFC, RF, 3G, LTE, LTE-A, etc. Herein, for example, the automated teller machine (ATM) 100 may be in communication with the mobile terminal 300 by means of the communication unit 110 over a 3G network system, may be in communication with the mobile server 200 over a LAN network, and may be in communication with the ATM switch server 23 over a LAN network, but are merely illustrative examples of the embodiment.

The control unit 120 may identify an approach of the mobile terminal 300 based on data received through the communication unit 110. For instance, when the mobile terminal 300, which has requested a transaction of cash deposit or withdrawal, informs an approach to the automated teller machine (ATM) 100 using an NFC technology or QR code after the approach (for example, this operation is referred to as “tapping”), the control unit 120 may identify the approach through the communication unit 110.

Further, if the data received via the communication unit 110 is the card information and the second security information stored in the mobile terminal 300, the control unit 120 may allow an alarm message, which is indicative of an approach of the mobile terminal 300 to the automated teller machine (ATM) 100, to be transmitted to the mobile server 200 via the communication unit 110.

Such an alarm message may include reservation information for identifying transaction information about a transaction of cash deposit or withdrawal in accordance with an embodiment of the present disclosure, and the reservation information may be used to identify transaction information that has been written by the mobile terminal 300 and then provided to the mobile server 200.

The control unit 120 may allow the mobile terminal 300 to request the financial computer network 20 associated with the automated teller machine (ATM) 100 to process a transaction of cash deposit or withdrawal requested by the mobile terminal 300, based on the card information, transaction information, and second security information. In this case, the card information may be the combination of the first card information and the second card information. Further, the first security information and the second security information may be combined to form a password of a card or a set of a key used to encrypt the password of the card and the password to be encrypted by the key.

In case where the set of the key and the encrypted password by the key is formed by combining the first security information and the second security information, the decryption unit 130 may decrypt the encrypted password using the relevant key. A technique to decrypt the encrypted password using the key is a well-known technique in the art, and therefore a detailed description thereof will be omitted.

Based on the password decrypted by the decryption unit 130, the automated teller machine (ATM) 100 in accordance with an embodiment of the present disclosure is able to perform a transaction of cash deposit or withdrawal in association with the traditional financial computer network 20. In this regard, the automated teller machine (ATM) 100 in accordance with an embodiment of the present disclosure may further include the encryption unit 140. The encryption unit 140 serves to re-encrypt the decrypted password. In this case, the encryption unit 140 may include, for example, an EPP (Encrypting Pin Pad) module, which is one of technologies known in a field of ARM-related encryption, and therefore, a detailed description thereof will be omitted.

Accordingly, the automated teller machine (ATM) 100 may be capable of receiving the first security information and the second security information that are separated, combining them together, decrypting them to derive a password, and encrypting again the password using the encryption unit 140 which may be an EPP module, thereby satisfying encryption requirements needed by the ATM switch server 23 in the financial network 10 in performing an even traditional transaction of cash deposit or withdrawal.

FIG. 6 is an exemplary sequential diagram illustrating a process of performing a transaction of cash deposit or withdrawal in a system including the automated teller machine (ATM) 100, the mobile terminal 300, the mobile server 200, and the financial computer network 20 in accordance with an embodiment of the present disclosure.

Hereinafter, a process that a transaction of cash deposit or withdrawal requested by the mobile terminal 300 is carried out through the automated teller machine (ATM) 100 will be described in detail with reference to FIG. 6 along with FIGS. 2 to 5, in accordance with an embodiment of the present disclosure.

First, as described in relation to FIG. 3, the mobile terminal 300 is provided with the second card information 410 stored therein in advance, and the mobile server 200 is provided with the first card information 420 stored therein in advance, where the second card information 410 and the first card information 420 are combined to form a whole card information, The mobile terminal 300 receives the transaction information about a transaction requested by a user of the mobile terminal 300, in operation 5100. This transaction information may include, but is not limited to, for example, amount of transaction, account number, an identity of a user, IDentification allocated to the mobile terminal 300, and others.

Next, the mobile terminal 300 may generate first and second security information based on a password, in operation 5110. In this case, in accordance with the embodiment, the first and second security information may be generated by encrypting the password using a key having a one-time random number. The first and second security information may be generated through a method of physically dividing the password or performing an XOR operation on the password, or through a method of physically dividing a key and a password encrypted by the key or performing an XOR operation on the key and the encrypted password.

Thereafter, the mobile terminal 300 transmits the transaction information entered by the user and the first security information to the mobile server 200 in operation S120. At this time, reservation information for identifying the transaction information may also be transferred in accordance with the embodiment of the present disclosure.

In this regard, an action of the mobile terminal 300 by which the transaction information and the first security information are transferred to the mobile server 200 may be referred to as a so-called ‘transaction reservation.’ This is because a relevant transaction will be substantially initiated only when the mobile terminal 300 approaches to the automated teller machine (ATM) 100, rather than transmits the transaction information to the mobile server 200.

Meanwhile, in operation 5130, when a user of the mobile terminal 300 who has done the ‘transaction reservation’ approaches to the automated teller machine (ATM) 100, the automated teller machine (ATM) 100 can recognize the approach of the mobile terminal 300. For example, the automated teller machine (ATM) 100 may recognize the approach from an event that the mobile terminal 300 transmits a signal indicative of the approach through the use of an NFC technology or QR code. However, the procedure of the notification of the approach and the recognition of the approach may be omitted depending on embodiments.

The automated teller machine (ATM) 100 may receive the second security information and card information on the card stored in the mobile terminal 300 from the mobile terminal 300, in operation 5140. Furthermore, the automated teller machine (ATM) 100 may also receive the reservation information from the mobile terminal 300 in accordance with the embodiment of the present disclosure. Herein, the card information may not be divided into the first card information and the second card information in accordance with the embodiment of the present disclosure, and this is the case, the card information received from the mobile terminal 300 may be the whole card information 400. Otherwise, in case where the card information is divided into the first card information and the second card information, the card information received from the mobile terminal 300 may be the second card information 410.

Subsequently, the automated teller machine (ATM) 100 may transmit to the mobile server 200 the alarm message that indicates the approach of the mobile terminal 300 to the automated teller machine (ATM) 100, in operation S150. This alarm message may include the reservation information for identifying the transaction information on the transaction of cash deposit or withdrawal in accordance with the embodiment of the present disclosure, and the reservation information may be used to identify the transaction information that has been written by the mobile terminal 300 and then provided to the mobile server 200.

Upon receiving the alarm message, the mobile server 200 may send the first security information and the transaction information to the automated teller machine (ATM) 100, in operation S160. In this case, the transaction information may be one that is identified by the reservation information included in the alarm message in accordance with the embodiment of the present disclosure. In addition, the mobile server 200 may send the first card information to the automated teller machine (ATM) 100 in case where the card information is divided into the first and second card information.

Accordingly, the automated teller machine (ATM) 100, which has received the second security information and the second card information from the mobile terminal 300, the first security information and the first card information from the mobile server 200, and the transaction information from the mobile server 200, may request the financial computer network 20 to process the transaction of a cash deposit or withdrawal based on the above mentioned information, of which description will be made in detail below.

The automated teller machine (ATM) 100 may generate a password by combining the first security information and the second information.

Or, in accordance with the embodiment of the present disclosure, the automated teller machine (ATM) 100 may derive a set of a key to encrypt a password and the password encrypted by the key by combining the first security information and the second information, and the decryption unit 130 included in the automated teller machine (ATM) 100 may decrypt the encrypted password using the key, in operation S170. A technique to decrypt the encrypted password using the key is a well-known technique in the art, and therefore a detailed description thereof will be omitted.

Next, based on the password decrypted by the decryption unit 130 and the card information, the automated teller machine (ATM) 100 in accordance with an embodiment of the present disclosure may carry out the transaction of cash deposit or withdrawal in association with the traditional financial computer network 20. In this regard, the automated teller machine (ATM) 100 in accordance with an embodiment of the present disclosure may further include the encryption unit 140. The encryption unit 140 may encrypt again the decrypted password in operation 5180, and the encryption unit 140 may be, for example, an EPP (Encrypting Pin Pad) module, which is one of technologies known in a related field to automated teller machine (ATM) encryption technologies, and therefore, a detailed description thereof will be omitted.

After that, the automated teller machine (ATM) 100 may request the financial computer network 20 to process the transaction based on the encrypted password, the card information, and the transaction information, in operation S200. In addition, as stated above, it is noted that the transaction information, the reservation, and the security information stored in the mobile server 200 may be automatically deleted when a predetermined time has elapsed.

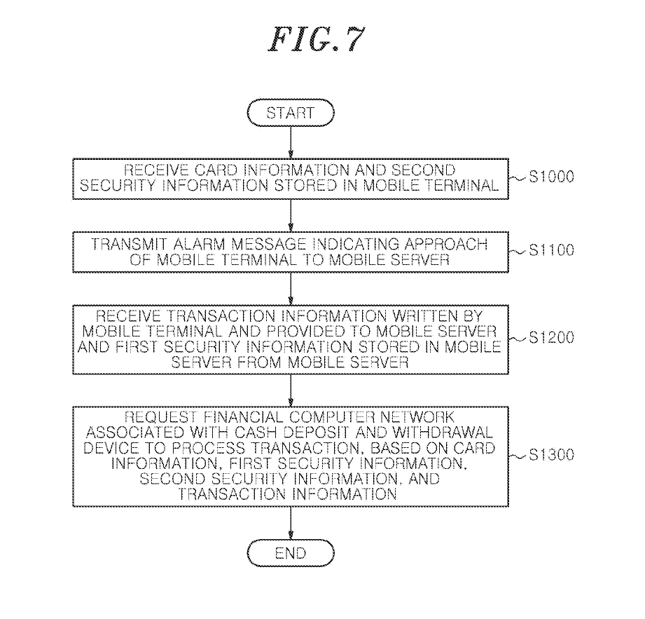

The above has been described, with reference to operations S100 to S200, in terms of a process in which a transaction of cash deposit or withdrawal requested by the mobile terminal 300 is processed by a system including the mobile terminal 300, the mobile server 200, the financial computer network the financial computer network 20, and the automated teller machine (ATM) 100. Hereinafter, a sequence in which a transaction of cash deposit or withdrawal is performed will be described with reference with FIG. 7 in accordance with an embodiment of the present disclosure.

FIG. 7 is an exemplary flow diagram illustrating a sequence in which a transaction of cash deposit or withdrawal is processed in the automated teller machine (ATM) in accordance with an embodiment of the present disclosure.

As illustrated in FIG. 7, in respect of the sequence in which a transaction of cash deposit or withdrawal is processed in the automated teller machine (ATM) in accordance with an embodiment of the present disclosure, in block S1000, the automated teller machine (ATM) 100 may receive the card information and the second security information stored in the mobile terminal 300. The description on the card information and the second security information will be omitted since it is the same as mentioned above. An operation in block S1100 may be carried out after the automated teller machine (ATM) 100 recognizes the mobile terminal 300 in accordance with embodiments of the present disclosure.

Next, in block S1100, the automated teller machine (ATM) 100 may transfer an alarm message, which is indicative of an approach of the mobile terminal 300 to the automated teller machine (ATM) 100, to the mobile server 200. As stated above, such an alarm message may include reservation information in accordance with an embodiment of the present disclosure.

Subsequently, in block S1200, the automated teller machine (ATM) 100 may receive the transaction information that has been written by the mobile terminal 300 and then provided to the mobile server 200 and the first security information that is stored in the mobile server from the mobile server 200. As stated above, it is understood that the automated teller machine (ATM) 100 may receive the card information from the mobile server 200.

Thereafter, in block S1300, based on the card information, first security information, and second security information, and transaction information, the automated teller machine (ATM) 100 may request the financial computer network 20 to process the transaction of a cash deposit or withdrawal. In this case, the automated teller machine (ATM) 100 may derive a set of a key to encrypt a password and the password to be encrypted by the key by combining the first security information and the second security information, decrypt the encrypted password using the key using the decryption unit 130, and re-encrypt the decrypted password using the encryption unit 140. As stated above, the encryption unit 140 may be an EPP module.

In accordance with embodiments of the present disclosure, a request for a transaction of cash deposit or withdrawal from the mobile terminal can be forwarded to the automated teller machine (ATM) via the mobile terminal, rather than the traditional financial network. Accordingly, it is possible for the automated teller machine (ATM) to perform the transaction of a cash deposit or withdrawal without forging the traditional financial network. Further, the security information and card information necessary for the transaction of a cash deposit or withdrawal are divided into segments and distributed between the mobile terminal and the mobile server before being transferred and combined by the automated teller machine (ATM) in accordance with an embodiment of the present disclosure, thereby avoiding the leakage of the information by a third party and preventing cash from being stolen due to the leaked information.

The embodiments of the present invention described above may be implemented in the form of program instructions that can be run through various components of computers and may be recorded on a computer-readable recording medium. The computer-readable recording medium may include alone or in combination with the program instructions, data files, data structures, and the like. The program instructions recorded on the computer-readable recording medium may be ones that are designed and constructed specifically for the present invention, or are known and available to those skilled in the computer software arts. Examples of the computer-readable recording medium may include magnetic recording media such as hard disks, floppy disks, and magnetic tapes; optical recording media such as CD-ROM and DVD; magneto-optical media such as floptical disks; and hardware devices such as ROM, RAM, flash memory, etc. that are specially configured to store and perform the program instructions. Examples of the program command include higher level codes that may be executed by a computer using interpreters as well as machine codes that are created by compilers. The hardware apparatus may be configured to act as one or more software modules in order to perform processes according to the present invention, and vice versa.

While the present invention has been shown and described with reference to specific matters such as the concrete components and definitive embodiments and drawings, these are merely provided only for the general understanding of the present invention, not limited to the foregoing embodiments, and may be changed and modified in various forms from the disclosure to a person having ordinary skill in the art to which the invention belongs.

Therefore, the spirit of the present invention is defined by the appended claims rather than by the foregoing embodiments, and all changes and modifications that fall within the claims, or equivalents thereof are intended to be embraced by the scope of the present invention.

What is claimed is:

1. A method for processing, in an automated teller machine (ATM), a transaction of a cash deposit or withdrawal requested by a mobile terminal, the method comprising:
receiving card information and second security information stored in the mobile terminal;
transmitting an alarm message, which is indicative of an approach of the mobile terminal to the automated teller machine, to a mobile server;
receiving transaction information, which has been written by the mobile terminal and then provided to the mobile server, and first security information, which is stored in the mobile server, from the mobile server; and
requesting a financial computer network associated with the automated teller machine (ATM) to process the transaction, based on the card information, the first security information, the second security information, and the transaction information;
wherein the first security information and the second security information are combined each other to form a password of a card of a user who owns the mobile terminal.

2. The method according to claim 1, wherein card information stored in the mobile terminal is the second security information that is a part of the card information on the card;
the mobile server is configured to store in advance first card information that is a remainder of the card information on the card except for the second card information;
said receiving transaction information and first security information includes additionally receiving the first card information; and
said requesting a financial computer network to process the transaction comprises requesting the financial computer network associated with the automated teller machine (ATM) to process the transaction, based on the first card information, the second card information, the first security information, the second security information, and the transaction information.

3. The method according to claim 1, further comprising, before the receiving card information and second security information step:
recognizing the mobile terminal's approach.

4. The method according to claim 1, wherein the first security information and the second security information are combined to form a set of a key to encrypt a password of the card and the password to be encrypted by the key.

5. The method according to claim 4, wherein said requesting a financial computer network to process the transaction comprises:
combining the first security information and the second security information to derive the key to encrypt a password of the card and the password to be encrypted by the key;
decrypting the encrypted password using the key;
re-encrypting the password, which has been decrypted, using an encryption unit included in the automated teller machine; and
requesting the financial computer network associated with the automated teller machine (ATM) to process the transaction, based on the re-encrypted password, the card information and the transaction information.

6. The method according to claim 5, wherein said encryption unit is EPP (Encrypting Pin Pad) module.

7. The method according to claim 1, wherein said receiving transaction information and first security information comprises:
additionally receiving the reservation information;
the alarm message includes the reservation information;
the mobile server is configured to include the transaction information that is identified by the reservation information;
the transaction information, which is received at said receiving transaction information and first security information, is identified by the reservation information; and
the reservation information is generated by the mobile terminal.

8. The method according to claim 1, wherein at least one of the transaction information and the first security information stored in the mobile server is deleted when a predetermined time has been elapsed.

9. An automated teller machine (ATM) for processing a transaction of cash deposit or withdrawal requested by a mobile terminal, the automated teller machine comprising:
a communication unit; and
a control unit configured to:
upon receiving card information and second security information stored in the mobile terminal, allow the mobile terminal to transmit an alarm message, which is indicative of an approach of the mobile terminal to the automated teller machine, to a mobile server via the communication unit; and
upon receiving transaction information, which has been written by the mobile terminal and then provided to the mobile server, and first security information, which is stored in the mobile server, via the communication unit, request a financial computer network associated with the automated teller machine (ATM) to process the transaction, based on the card information, the first security information, the second security information, and the transaction information;
wherein the first security information and the second security information are combined with each other to form a password of a card of a user who owns the mobile terminal.

10. The automated teller machine according to claim 9, wherein the card information stored in the mobile terminal is the second security information that is a part of the card information on the card;
the mobile server is configured to store in advance first card information that is a remainder of the card information on the card except for the second card information; and
if the control unit receives the first card information through the communication unit in addition to the second card information, the first security information, the second security information, and the transaction information, the control unit is configured to request a financial computer network to process the transaction comprises requesting the financial computer network associated with the automated teller machine (ATM) to process the transaction, based on the first card information, the second card information, the first security information, the second security information, and the transaction information.

11. The automated teller machine according to claim 9, wherein the first security information and the second security information are combined to form a set of a key to encrypt a password of the card and the password to be encrypted by the key.

12. The automated teller machine according to claim 11, wherein the control unit is configured to combine the first security information and the second security information to derive the key to encrypt a password of the card and the password to be encrypted by the key and
the automated teller machine further comprises a decryption unit, the decryption unit decrypting the encrypted password using the key.

13. The automated teller machine according to claim 12, further comprises an encryption unit configured to re-encrypt the password, which has been decrypted, and the control unit requests the financial computer network associated with the automated teller machine (ATM) to process the transaction, based on the re-encrypted password, the card information and the transaction information.

14. The automated teller machine according to claim 13, wherein said encryption unit is EPP (Encrypting Pin Pad) module.

15. The automated teller machine according to claim 9, wherein the control unit receives transaction information and second security information and additionally receives the reservation information via the communication unit;
the alarm message includes the reservation information;
the mobile server is configured to include the transaction information that is identified by the reservation information;
the transaction information which is received from said mobile server is identified by the reservation information; and
the reservation information is generated by the mobile terminal.

16. The automated teller machine according to claim 9, wherein at least one of the transaction information and the first security information stored in the mobile server is deleted when a predetermined time has been elapsed.
